(19) United States
(12) Patent Application Publication
(10) Pub. No.: US 2010/0094814 A1
(43) Pub. Date: Apr. 15, 2010

(54) Assessment Generation Using the Semantic Web

(76) Inventor: James Alexander Levy, San Diego, CA (US)

Correspondence Address: GEORGE S. LEVY, 3980 DEL MAR MEADOWS, SAN DIEGO, CA, 92130, US

(21) Appl. No.: 12/577,716

(22) Filed: Oct. 12, 2009

Related U.S. Application Data
(60) Provisional application No. 61/104,896, filed on Oct. 13, 2008.

(51) Int. Cl. G06F 17/30; G06F 9/44; G06N 7/06; G06N 7/02

(52) U.S. Cl. 707/694; 707/E17.044; 706/52; 707/E17.108

(57) ABSTRACT

This invention is a method of generating an assessment items. It comprises configuring an assessment generation engine running on a database or an information network such as the Web to produce when a topic is specified a) an incomplete statement or a question about said topic, which are called the semantic context; and b) a right answer and at least one wrong answer, each answer in a form suitable to complete the incomplete statement or to answer the question; The method also comprises operating the assessment generation engine to produce an assessment item comprising the semantic context, the true answer and the wrong answers. The method yet comprises producing the assessment item in a material form configured to be administered to an assessment taker.

This invention claims the benefit of U.S. Provisional Application No. 61/104,896 with the title, “Quiz Generation Using the Semantic Web” filed on Oct. 13, 2008 and which is hereby incorporated by reference. Applicant claims priority pursuant to 35 U.S.C. Par 119(e)(i). The present invention relates to computers and the Internet. It also relates to computerized education and computerized assessment. Specifically, it relates to generation of assessment questions using information from the Web, administration of these questions to assessment takers and assessment of their proficiency.

### INCORPORATION BY REFERENCE

Material incorporated by reference include:
a) U.S. Pat. No. 7,197,459 by Harinarayan titled “Hybrid machine/human computing arrangement.”
b) U.S. Pat. No. 4,839,853 by Scott Deerwester et al. titled Computer information retrieval using latent semantic structure
c) Matthew Brand (2006). “Fast Low-Rank Modifications of the Thin Singular Value Decomposition”. Linear Algebra and Its Applications 415: 20-30. doi:10.1016/j.laa.2005.07.021.
d) Thomas Landauer, P. W. Foltz, & D. Laham (1998). “Introduction to Latent Semantic Analysis” (PDF). Discourse Processes 25: 259-284.
e) S. Deerwester, Susan Dumais, G. W. Furnas, T. K. Landauer, R. Harshman (1990). “Indexing by Latent Semantic Analysis” (PDF). Journal of the American Society for Information Science 41 (6): 391-407. doi:10.1002/(SICI)1097-4571(199009)41:6<391::AID-ASI1>3.0.CO;2-9.
f) Michael Berry, S.T. Dumais, G. W. O'Brien (1995). Using Linear Algebra for Intelligent Information Retrieval.

### FIELD OF THE INVENTION

### Background

To effectively assess or certify proficiency of a person in a certain knowledge domain, a method of measuring this proficiency must be specified. When new knowledge becomes accessible, this method must be capable of incorporating this new knowledge. In relatively static areas, this isn't a problem. But the most quickly evolving areas of science and technology defy the pace at which standardized assessments and certifications can be made. The great importance of assessing these proficiencies in quickly evolving areas therefore necessitates a technology that can be more efficient in accessing fresh information related to a given topic, formatting this information in the form of assessments, administering these assessment s to assessment takers, and evaluating both the proficiencies of assessment takers and the difficulty of assessment material.

The Web is an ever changing gigantic repository of knowledge—much of it at the forefront of scientific and technological discourse. This material can be mined to generate such assessment.

This assessment generation technology would find application in the field of human resources for the assessment of prospective employees. It may also be of significant use in the field of education, where assessments would be generated for the assessment and teaching of students, as well as for the maintenance of professional competency in fields such as, but not limited to, law, medicine or engineering. The ability of this technology to generate news breaking material may benefit news media, social media, and political culture. Other applications of such technology may be found in advertising, public relations, and entertainment. The above examples are meant to indicate some uses of such assessments but should not be construed as limitations in the diversity of application of these assessments.

### BRIEF DESCRIPTION OF THE DRAWINGS

FIG. 1 is a functional block diagram of the invention. It shows selecting a topic to be used to generate a list of URLs; URLs yielding raw data that can be semantically analyzed to produce the semantic entities can be used to generate right and wrong answers; constructing assessment items and editing by humans of these assessment items; and the estimation of the difficulties of the assessment items and of the proficiencies of the assessment takers.

FIG. 2 shows how The Wrong Answer Engine (WAE) (Wrong but Plausible Answer Engine) operates. Given an input topic, the types associated with the input topic can be used to identify different instances of the input topic.

FIG. 3 shows how the task of estimating the difficulties of the assessment items and the proficiencies of the assessment takers can be framed as a neural network problem.

FIG. 4 illustrates how a simplified Kalman Filter can be used to estimate the difficulties of the assessment items and the proficiencies of the assessment takers.

FIG. 5 shows how expected scores can be calculated from estimated difficulties and estimated proficiencies.

### SUMMARY OF THE INVENTION

This invention is a method of generating one or more assessment items. It comprises:
a) configuring an assessment generation engine running on a database or an information network such as the Web to produce when a topic is specified:
   i) an incomplete statement or a question about the topic. This incomplete statement or question is called the semantic context; and
   ii) a right answer and at least one wrong answer, each answer in a form suitable to complete the incomplete statement or to answer the question;
b) operating the assessment generation engine to produce an assessment item comprising the semantic context, the true answer and the wrong answers; and
c) producing the assessment item in a material form configured to be administered to an assessment taker.

Wrong answers can be generated in a semantic network by parallel instantiation which comprises:
a) Locating the right answer in a graph (semantic network) where each topic has one of more “type” attributes, and may additionally have other attributes;
b) Finding the type attributes and other available attributes associated with the right answer
c) Finding other instances associated with these types and attributes.

Wrong answers can also be generated by using Resource Description Frameworks (essentially a database of triplets, each triplet consisting of a subject, a predicate and an object). This method comprises:
a) locating a Resource Description Framework in which one of its three elements matches the topic, and a second of its three elements matches the right answer;
b) locating a second resource description framework in which the first of its elements is identical to the corresponding first element in the first resource description framework, in which the third element is different from the third element in the first resource description framework;
c) assigning the second element of the second resource description framework as a wrong answer.

The plausibility of a wrong answer can be evaluated by using fuzzy logic. Given a set of fuzzy attributes defining a right answer, the fuzzy plausibility of a wrong answer can be calculated by calculating how far the wrong answer attributes are from the right answer.

Latent semantic analysis can also be used to calculate the plausibility of a wrong answer by providing a means for calculating distance between topics.

This method of generating assessments can be monitored and edited by a human being. In addition, the human being can improve the semantic database used by the assessment program by adding ontological information.

When the assessment program makes use of a query engine to mine the Web for information, the following process can be employed:
a) selecting a list of URLs associated with the topic of interest;
b) retrieving from the Web raw data associated with the list of URL's;
c) performing a semantic analysis on the raw data, to generate a right answer and a semantic context.
   The URLs can be generated by inputting the topic into a Web search engine, or into a social bookmark service. URL's can also be generated by finding them on semantic tags on the Web, in a predetermined table, in Outline Processor Markup Language (OPML) files and in Really Simple Syndicated (RSS) feeds.

Assessment takers can be rated by associating with each assessment item a degree of difficulty and with each assessment taker, a degree of proficiency. An estimation algorithm can then use the degrees of difficulty and the degrees of proficiency as state vectors to evaluate assessment takers.

Variations in the assessment format include generating a correct statement and at least one incorrect statement about a topic and presenting the assessment item as a true/false quiz (if only one incorrect statement is available) or as a multiple choice quiz (if multiple incorrect statements are available). Assessment items can have many forms such as, but not limited to, true/false, multiple choice and fill-in-the-blank. Assessment takers are evaluated by administering assessment items to them.

### DETAILED DESCRIPTION

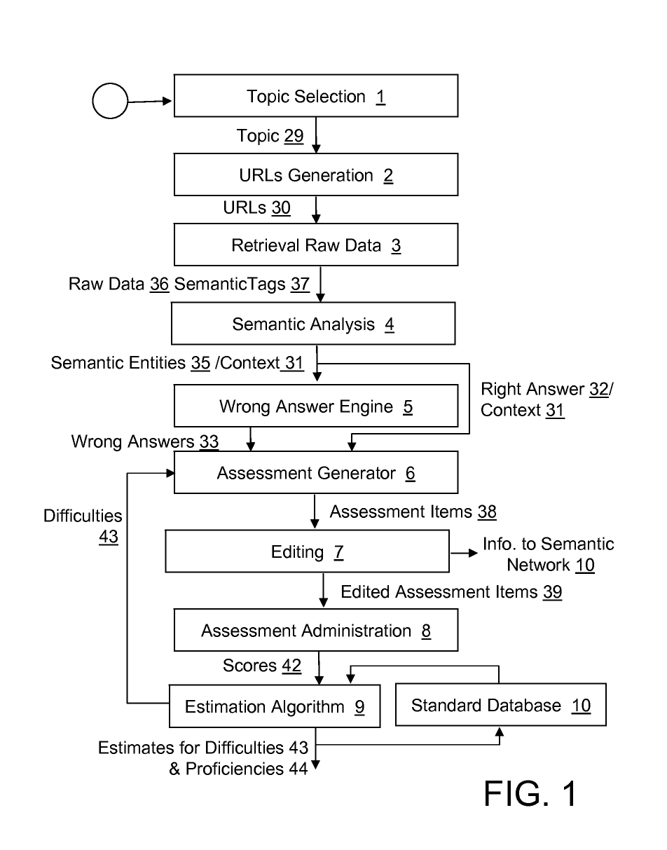

This invention is a method that generates assessments using information available on the Web. As shown in FIG. 1 this method essentially comprises the following:

Topic Selection 1

A topic 29 is specified and selected by a human being using a graphical user interface, or as the result of an automatic computerized process.

URLs Generation 2

A list of URLs 30 containing content related to topic 29 is generated by searching for pages identified with the topic—this can be accomplished in many possible ways:
a) Maintain a database of URLs associated with each topic and use this database to return a list of URLs when queried with a given topic.
b) Use a third-party database of URLs associated with each topic, such as Wikipedia pages.
c) Use a search engine to return a list of URLs for a given topic. For example, Google™ and Twitter™ have a search API. Given a topic as an input search term, this API returns a list of ranked pages mentioning this topic.
d) Use a social bookmarking service such as Delicious™. These services employ social tagging, classification and indexing, to collaboratively create and share Web entities annotated and categorized by content. Delicious™ provides an API that, when queried with a particular topic, returns a list of URLs.
e) Use tools available on the Semantic Web. For example, searches could be conducted to look for machine readable metadata corresponding to the selected topic. For example, the Dublin Core metadata standard could be used as metadata search targets. A simple Dublin Core for example, consists of the following 15 metadata elements: (Title; Creator; Subject; Description; Publisher; Contributor; Date; Type; Format; Identifier; Source; Language; Relation; Coverage; Rights.) A more specific example would be to search for URLs containing metadata in the form of a Dublin core in which the desired topic is encoded in the subject field.
f) Alternatively the URLs could be specified directly without the requirement for a topic.

Retrieval of Assessment Raw data 3

The next step is to download or otherwise retrieve the information associated with the specified URL's. This information called the assessment Raw Data 36 can comprise text, images, sounds or video. Preferably, it is semantically tagged to facilitate its analysis.

Semantic Analysis 4

Each URL 30 is sent to a semantic analysis tool. For example, given a webpage as an argument, this tool identifies unique Semantic Entities 35 and their associated Semantic Context 31. Semantic Entities 35 may be anything with semantic value, for example words, expressions, images, video clips or audio clips. The Semantic Context 31 is the paragraph or frame in which the Semantic Entity 35 is embedded but does not include the Semantic Entity 35. Thus the Semantic Context 31 is an incomplete paragraph or an incomplete expression with the Semantic Entity 35 blanked out. Using the Semantic Entity 35 to fill the blank in the Semantic Context 31 is, therefore, the right response in a fill-in-the-blank test and the Semantic Entity 35 is also the Right Answer 32.

Therefore, the Semantic Context 31 forms the basis of an assessment question. The Semantic Entity 35, itself, is assigned as a Right Answer 32. As shall be explained below, the Wrong Answer Engine finds a different but contextual plausible word or expression that can replace the Semantic Entity 35 in its Semantic Context 31. A true statement is defined as the Semantic Context 31 with the original and appropriate embedded Semantic Entity 35. A false statement is defined as a Semantic Context 31 in which the Semantic Entity 35 has been replaced with a different but contextually plausible word or expression.

Parsing for Semantic Tags 37

The mechanism for performing the semantic analysis could make use of a formal linguistic parsing program. Alternatively, if the Web content is already tagged, the semantic analysis task can be greatly simplified. The semantic analysis could be accomplished by simply parsing for Semantic Tags 37. An HTML search/parsing tool on the server can then be used to locate Semantic Entities 35 with corresponding Semantic Tags 37 within the Raw Data 36.

Common Tag is one of many currently popular semantic tagging standard of interest and is discussed here as an example. Its structural model is very simple. It states that a piece of content addressable through a URL (a “resource”) can be “tagged” with one or more tag structures. Each tag can contain a pointer to another resource that identifies the concepts described by the content, unambiguously indicating what the content “means.” Optionally, the tag may also contain information about when the tag was created (the “tagging date”) and what human readable “label” should be used when listing the concepts covered in the content.

If the semantic analysis tool is operated by a third-party service (such as OpenCalais or Zemanta), the results of the semantic analysis can be formatted as a machine-readable document, which can be downloaded by the assessment generation program.

Object-Oriented Topic Graph

The data schema used to organize correct answers as well as incorrect answers (to be discussed below) is an object-oriented graph of topics. Each topic is an object with attributes, and attribute values. Each topic may be assigned “type” attributes describing sets to which the topic belongs. Each topic may also have additional attributes describing values of the topic that are more specific than a ‘type’ attribute. For instance, an Apple is a type of Fruit with attributes of color, taste, and shape that distinguish it from other topics that are types of Fruit. Not all topics must share all attributes, but topics do share many attributes, and similar topics tend to share more attributes. Each topic has attribute values for each attribute key. Many attribute values are IDs of other topics. For instance, if one topic represents a historical person, the value of their ‘Parent’ attribute would be an ID for the topic representing that historical person's father or mother. Attributes can also have types not representing other topics, such as numerical, Boolean, or text, or binary representing some other form of content such as audio or video.

Supplemental attribute key:value pairs, visualization objects, or content objects from a distributed world-wide set of datasets can be retrieved by linking them to the given topics in question through joining datasets through use of a shared key, such as a Common Tag or other resource address.

Wrong Answer Engine 5

The next step of the process is to use the Semantic Entity 35, the Semantic Tags 37 and Semantic Context 31 to generate one or several Wrong Answers 33. This operation is performed by the Wrong Answer Engine (WAE). This module generates plausible but Wrong Answers 33. It takes a Semantic Entity 35 as an input and returns a list of topics that bear a certain degree of similarity with it. Several approaches can be used.
a) Wrong Answer by Parallel Instantiation;
b) Wrong Answers by Alteration of Resource Description Frameworks;
c) Wrong Answer Plausibility Determination Using Latent Semantic Analysis;
d) Wrong Answers Using Fuzzy Logic.

a) Wrong Answer by Parallel Instantiation

This module makes use of a semantic network such as the Freebase™ database. The difference between two concepts embodied, for example, by a Right Answer 32 and a Wrong Answer 33, can be expressed in the semantic schema. More specifically, one possible way of generating Wrong Answers 33 is as follows:
a) start by expressing a Right Answer 33 as a particular instance in the semantic schema;
b) go up one or more one level in the semantic tree to the parent type;
c) select a different instance from the original one; and
d) go down one level or more level to that new instance.

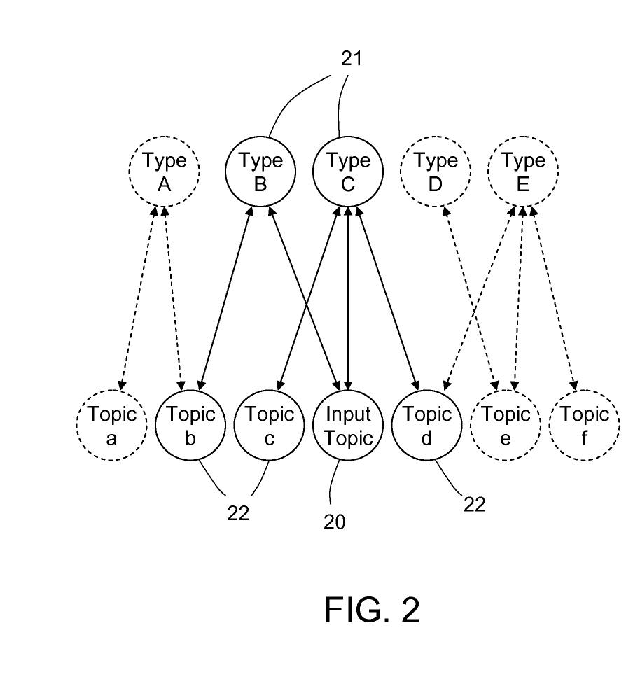

A simple example illustrating the parallel instantiation process is shown in FIG. 2: given the input topic 20 (i.e., Right Answer 32) all of the types 21 associated with the input topic 20 are returned. This can be implemented with the Freebase™ service by issuing the following MQL command:

[{

“name” : {{Right_Answer}},
“type” : [ ],

}]

Upon receiving a list of types “ty” associated with the Right Answer, a second query is issued for each type “ty” to produce an instance of each type. This query generates a list of topics 22.

[{

“name” : null,
“type” : “{{Right_Answer_Types[ty] }}”,
“id” : null

}]

The retrieved topics 22 share inherited types with input topic 20. Clearly, other methods of exploiting a semantic schema to generate plausible but Wrong Answers 33 also exist.

Alternatively, the degree of similarity between topics can be based on inferences from other sources, such as aggregated user-generated data from search engines or social networks. For example, the returned topics can be those found to be frequently coupled with the input topic in search requests, indicating similarity.

b) Wrong Answers by Alteration of Resource Description Frameworks.

Another possible implementation of The Wrong Answer Engine 5 can involve the use of Resource Description Framework (RDF) entities. Each RDF entity contains a subject, a predicate and an object:
RDF=(Subject, Predicate, Object)

The Wrong Answer Engine 5 uses a database of RDF relations. Let's say that this RDF database contains one RDF entity such that the subject field corresponds to the input topic and the Object field corresponds to the Right Answer 32.
RDF1=(Input Topic, Predicate1, Right Answer)

One may generate a set of wrong (but related) answers by looking for object fields in RDFs which contain the same subject field but a different predicate.
RDF2=(Input Topic, Predicate2, Wrong Answer)

For example considers the following relations describing Shamu the whale:
RDF1a=Shamu Is a Mammal
RDF1b=Shamu Swims-Like a Fish

Using the incorrect predicate would result in the incorrect statement:
RDF2=“Shamu Is a Fish.”

Wrong Answer Plausibility Determination Using Latent Semantic Analysis

In this approach the distance between topics is measured in a Euclidean latent space. The object-oriented topic graph can be represented as an adjacency matrix or other form of latent space. Eigendecomposition of this adjacency matrix (or the scalar product when the topic graph is represented in a latent space) provides components representing an estimated plausibility rank, where wrong answers 33 are ranked according to how closely their plausibility as a correct answer is to an optimal difficulty level for the given quiz item.

Each of these distances represents an estimation of the given wrong answer's plausibility, or believability to the end-user, in place of the given correct answer. The results of these estimations can be incorporated as feedback to assign weights to attributes representing the attribute's reliability in determining a plausibility score. More information about Latent Semantic Analysis can be found in the following documents:
a) U.S. Pat. No. 4,839,853 by Scott Deerwester et al. titled Computer information retrieval using latent semantic structure
b) Matthew Brand (2006). “Fast Low-Rank Modifications of the Thin Singular Value Decomposition”. Linear Algebra and Its Applications 415: 20-30. doi:10.1016/j.laa.2005.07.021.
c) Thomas Landauer, P. W. Foltz, & D. Laham (1998). “Introduction to Latent Semantic Analysis” (PDF). Discourse Processes 25: 259-284.
d) S. Deerwester, Susan Dumais, G. W. Furnas, T. K. Landauer, R. Harshman (1990). “Indexing by Latent Semantic Analysis” (PDF). Journal of the American Society for Information Science 41 (6): 391-407. doi:10.1002/(SICI)1097-4571(199009)41:6<391::AID-ASI1>3.0.CO;2-9.
e) Michael Berry, S.T. Dumais, G. W. O'Brien (1995). Using Linear Algebra for Intelligent Information Retrieval.

d) Use of Fuzzy Logic to determine Plausibility of Wrong Answers. Yet another method of generating wrong answers is to use a database in which topics are described in terms of a function of its fuzzy logic attributes. The truthfulness (or plausibility) of the answer could then be described of its fuzzy logic value—for example continuously ranging from 0.0 for completely wrong to 1.0 for completely true). A true answer would then be arbitrarily defined as any topic whose truthfulness falls, for example, between 0.9 and 1. A plausible but wrong answer would then be defined as any topic falling in the range, for example, between 0.7 and 0.9. Thus to generate such a wrong answer one would perform the following:
a) Extract form the context (the question or incomplete statement) a set of fuzzy attributes that would define a right answer. This may be done for example if the test is annotated with XML tags to specify these attributes in advance. Otherwise, more elaborate artificial intelligence techniques may be used.
b) Perform a variation analysis on the database: starting with the fuzzy attributes, generate variations in those attributes and search the database for topics having these attributes that make the topic fall within the desired range of plausibility.
   The output of the search would then consist of topics representing wrong answers with the desired plausibility.

Difficulty Level Customization. Wrong-answers 33 are selected based on how close their plausibility score is to an optimal difficulty level for the given quiz item. To personalize quiz items for each quiz taker, the Wrong Answer Engine 5 may specify a custom optimal difficulty level to create a custom set of plausibility ranks and therefore may select a custom selection of wrong answers 33.

Assessment Generator 6

The next step is to generate an assessment item 38. The assessment item is comprised of the following:
a) an assessment statement. Essentially this statement comprises the assessment context (for example a paragraph or a sentence) left ambiguous by blanking out the embedded Semantic Entity 35;
b) the Right Answer 32 which can be the Semantic Entity 35;
c) the set of Wrong Answers 33.

Essentially the task is similar to generating a multiple choice quiz. The output of the assessment generator is an Assessment Item 38. For example an assessment could be of the form:
“Fortran is a general-purpose, ______, imperative programming language that is especially suited to numeric computation and scientific computing.”

Replace blank by the most appropriate term below:

i) Procedural

ii) object oriented

iii) parallel

iv) English

The Right Answer 32 is “procedural.” All others are wrong but plausible answers.

It is clear to persons having skill in the art that many variations can be employed on this basic scheme to generate many kinds of quiz items, such as but not limited to
a) true/false;
b) multiple choice;
c) fill-in-the-blank that requires an assessment taker to enter his own answer without providing him with multiple choice. (For example: “What is the composition of water? Hydrogen and ______? Clearly the only answer is Oxygen and any other answer would be wrong. In this case the assessment taker would not be provided with a list of terms to pick from such as “Oxygen, Nitrogen, Carbon, Air, Water Vapor.”
d) numerical. The assessment taker would be required to enter the correct numerical value to complete an assessment statement, for example, “The value of PI to three significant figures is ______.” The answer of course is 3.14.

If a difficulty ranking is available at this point, the assessment items could be ranked according to their difficulty. Otherwise, as shall be described below, an algorithm can be employed to estimate the difficulties of assessment items and the proficiencies of assessment takers using measured score data.

In addition, the type of questions does not have to be limited to text but could include images, audio and video. The questions format can be decided by the software on the basis of Semantic Tags 37 associated with the Raw Data 36.

Editing 7

As an option, the Assessment Item 38 can be given to a human moderator for editing. U.S. Pat. No. 7,197,459 by Harinarayan and entitled “Hybrid machine/human computing arrangement” which discusses how humans can assist a computer to solve particular tasks, is hereby incorporated by reference as already mentioned in the first paragraph. An editing interface can be provided to allow a human to select and edit the Assessment Items and rank them by degrees of difficulty. For example, the human assistant who has access to the Right Answer 32 could edit the Semantic Context 31. For instance, he could remove from the Semantic Context 31 “giveaway” references to the Right Answer, and adjust the boundaries of where the item text begins and ends. The human assistant could also select the most plausible but wrong choices among the Wrong Answers 33, and adjust the estimated degree of difficulty of the assessment item. After editing, the Assessment Items 38 are called Edited Assessment Items 39.

Each Edited Assessment Item 39 is saved to the database with a link back to its originating URL, which in turn links back to its parent topic. This metadata can later be used in the Ranking process.

Production of the Assessment

The edited assessment 39 is produced in a material form that can be read or otherwise understood by a human being, for example in print, on an electronic display, or aurally. The assessment presentation requires the assessment taker to make a choice between the Right Answer and the Wrong Answers 33.

Assessment Administration 8

Assessment Takers use an Assessment Taker interface to take assessments which comprise Assessment Items. There are many possible ways of presenting an assessment item. For example, the content of each item resembles a fill-in-the-blank, where the Right Answer 32 is must be chosen from among many Wrong Answers 33. In addition, there may also be a timer measuring the time it takes to answer the question, and/or giving the Assessment Taker limited time to answer the question.

Rendering Quiz Items Using Supplemental Content and Visualized Answer Representations: Supplemental data and content such as images or video can be linked to the given correct answer topics and wrong answer topics through aforementioned disambiguation methods to join sets of linked data. This supplemental data and content can be used to render the quiz answers to the interface in richer forms, such as rendering answers as data visualizations if a rich dataset can be linked to the given wrong answer, or image or video content that can be linked to the given wrong answer.

Estimation Algorithm 9

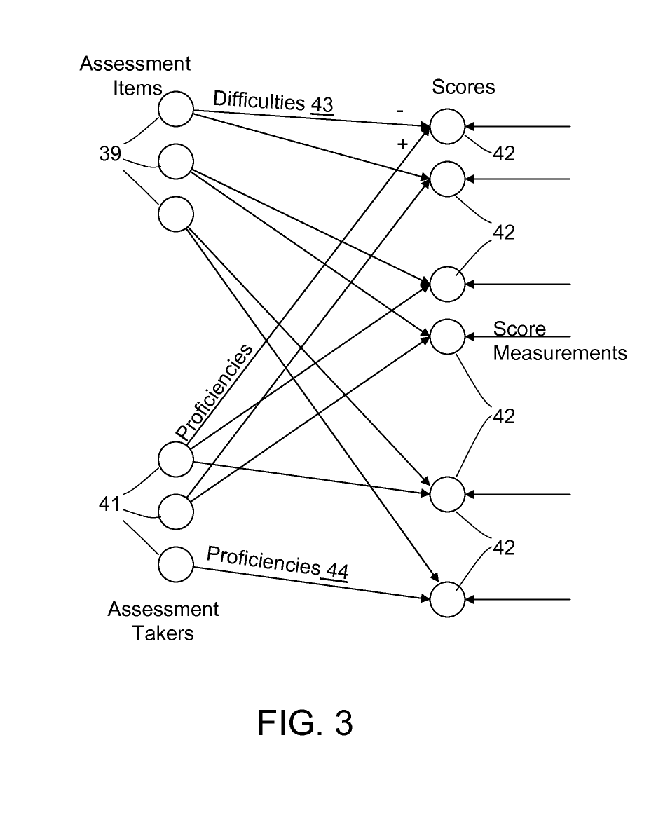

After the administration of the assessment test, the answers generated by the assessment takers as well as their response times are recorded. The data generated by the administration of the assessment includes score data, each data score item corresponding to the performance of a single assessment taker taking a single assessment item. The relationship between scores 42, Assessment Items 40, Assessment Takers 41 proficiency 44 and difficulty 43 is illustrated in FIG. 3. A score 42 is defined as the performance of one assessment taker 41 on a single Assessment Item 40. The scores 50 are computed as a function of whether the answers provided by the Assessment Takers 41 are correct or not, and of the time the Assessment Takers 41 need to answer each question.

Using the aggregate score results as an input, an algorithm is used to calculate the degree of difficulty for each assessment item (or single question) and the degree of proficiency for each assessment taker. As is evident for those skilled in the art there are many methods of solving this problem, for example but not limited to, least square, gradient technique and Kalman filtering. One possible approach is to begin by defining the following two quantities:
a) The degree of difficulty 43 for each assessment.
b) The degree of proficiency 44 for each assessment taker.

The problem is then reduced to estimating the degree of proficiency of the assessment takers given the scores 42 data.

Least Square Estimation: A state X vector can be defined as the concatenation of the Difficulty vector and the Proficiency vector:

x=(d₁, d₂, d₃, . . . dₘ, p₁, p₂, p₃, . . . pₙ)

where (dᵢ, d₂, d₃, . . . dₘ) is the Difficulty vector (each vector element assigned to each assessment item and (pᵢ, p₂, p₃, . . . pₙ) is the Proficiency vector, each vector element assigned to each assessment taker.

For a given score, s, linked to assessment item, i, and assessment taker, j, the score sₖ can be calculated as

sₖ=−dᵢ+pⱼ

where the values of dᵢ, and pᵢ are assumed to range from 0 to 1 and the values for sₖ are assumed to range from −1 to +1. The measurement vector h corresponding to this score is therefore

h=(0, 0, 0, . . . −1, 0, 0, . . . +1, 0, 0, . . . 0)

where −1 corresponds to −dᵢ, and +1 corresponds to pⱼ.

### Therefore:

sₖ=h x^{T}

For the set of all scores expressed by the vector s, let H be the measurement matrix. Since s=Hx^{T}

H^{T}s=(H^{T}H)x^{T}

The least square estimate of x is therefore given by:

x^{T}=(H^{T}H)⁻¹Hs

Neural Net Implementation: FIG. 3 illustrates how assessment items 39, assessment takers 41 scores 42, difficulties 43 and proficiencies 44 can be viewed as a neural network. In this particular case, backpropagation could be used to solve for the difficulties and proficiencies given the score values.

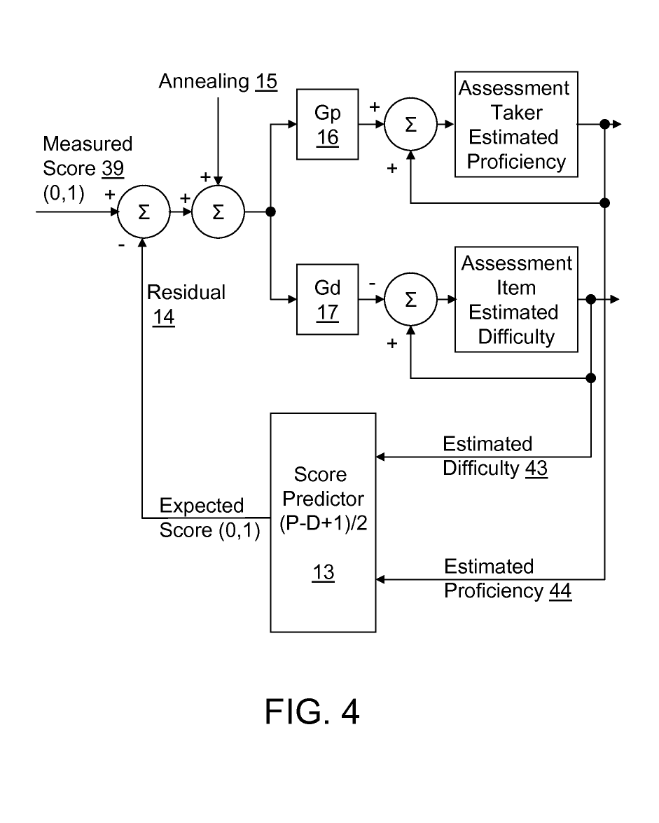

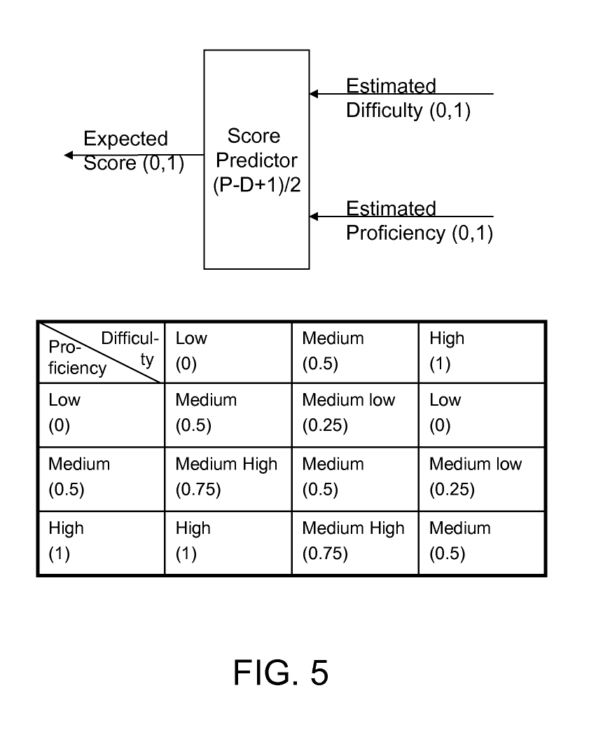

Kalman Filter: One could also use a Kalman Filter to estimate the difficulties of the assessment items and the proficiency of the assessment takers. FIG. 4 illustrates a simplified Kalman Filter implementation wherein, akin to a simple gradient method, the covariance matrix is restricted to diagonal values only. Whereas in this method, convergence per algorithm cycle may be slower than in a conventional Kalman Filter, the computations are significantly simpler. In the figure, the proficiency states 44 and the difficulty states 43 are shown separately. As shown in FIG. 5 each expected score can be calculated in the feedback loop 13 from the estimated values of the difficulty of the assessment item and the estimated value of the proficiency of the assessment taker. The equation below assumes that the values for Difficulty, Proficiency and Score range from 0 to 1.

Expected Score=(Proficiency−Difficulty+1)/2

The expected score is subtracted from the measured score to generate an error signal called a residual 14. Optionally, in a technique called simulated annealing, a small noise signal 15 can be added to the residual 14 to overcome the existence of local minima in the error signal.

The residual 14 is then multiplied by the gains Gₚ 16 and G_{d} 17 to produce the amount of change that should be applied to the Difficulty states and to the Proficiency states. In this simplified Kalman Filter, the gains are scalars, as in a conventional gradient method. As the number of state corrections increases, the uncertainty associated with the estimates decreases. Consequently, as more scores are processed by the algorithm, the gains can be made to decrease in order to provide a greater weight to the latest estimates in comparison with the new score measurements. One of the advantages of this method compared to the least square approach discussed above is that it can be used incrementally rather than in batch: each new score can be processed by itself to improve the accuracy of the whole database.

Development of a Standard Database 10

Once a database is developed that contains a satisfactory estimate of the difficulties of assessment items and the proficiencies of assessment takers, one may want to prevent any more changes to the difficulties 43 and the proficiencies 44 and keep the database constant. When a new set of scores linking new assessment items to new assessment takers becomes available, the assessment items' difficulties and the assessment takers' proficiencies can be calculated by running the new scores through the simplified Kalman Filter algorithm. To prevent changes to the existing database, only corrections to the difficulties of the new assessment items and the proficiencies of the new assessment takers should be allowed.

Machine Learning via Quiz Administration Feedback. The user's choice of answer when the quiz is administered can be used as feedback to determine weights for the reliability of each of the wrong answer's topics attributes or supplemental topic attributes to determine the plausibility score required to select wrong answers at the optimal difficulty level.

Writing to Semantic Network 11

Semantic databases may be enhanced through human computation, such as confirming that a topic belongs to a certain ontological category. By making these computations in the assessment editing process, it may be possible to write useful semantic information back to semantic databases such as Freebase™. For example an assessment editor may confirm that a selected Wrong Answer 33 should be co-assigned to one of the semantic types of the Right Answer with a write operation:

[{

“id” : {{ Wrong_Answer.id }} ,
“type” : {{ Right_Answer_Types[s] }}

}]

Therefore, in the process of editing an assessment, a human being, can increase the knowledge of a database or information network from which the assessment is generated by 1) generating ontological information, and 2) feeding back this ontological information into the database or information network.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

I claim:

1. A method of generating at least one assessment item comprising:
a) configuring an assessment generation engine running on a database or an information network to produce when a topic is specified:
i) an incomplete statement or a question about said topic, said incomplete statement or said question being called semantic context;
ii) a right answer in a form suitable to complete said incomplete statement or to answer said question; and
iii) at least one wrong answer in a form suitable to complete said incomplete statement or to answer said question;
b) operating said assessment generation engine to produce at least one said assessment item, each comprising its own said semantic context, its own said right answer and its own said at least one wrong answer; and
c) producing said assessment item in a material form configured to be administered to an assessment taker.

2. The method of generating said at least one assessment item of claim 1 wherein said at least one assessment item is in the form of a multiple choice answer quiz.

3. The method of generating said assessment item of claim 1 wherein said database or network is the Web.

4. The method of generating said assessment item of claim 1 also comprising administering said at least one assessment items to said assessment takers, said assessment takers being given the task of choosing between said true answer and said wrong answer.

5. The method of generating said at least one assessment item of claim 1 wherein for each said assessment item, said generating said at least one wrong answer is performed by parallel instantiation in a semantic network characterized by types and attributes, said parallel instantiation comprising:
a) locating said right answer as an instance in said semantic network;
b) finding said types and said attributes associated with said right answer;
c) finding other instances associated with said types.

6. The method of generating said at least one assessment item of claim 1 wherein, for each said assessment item, said generating said at least one wrong answer per said assessment item is performed by alteration of a resource description framework, each said resource description framework comprising three elements, said alteration of a resource description framework comprising:
a) locating a resource description framework wherein a first of its said three elements matches said topic, and a second of its said three elements matches said right answer;
b) locating a second resource description framework wherein first of its said three elements is correspondingly identical to said first element of said first resource description framework, and wherein third of its said three elements is different from said third element of said first resource description framework;
c) assigning the second element of said second resource description framework as one of said at least one wrong answer.

7. The method of generating said at least one assessment item of claim 1 wherein, for each said assessment item, said generating said at least one wrong answer per said assessment item is performed by using latent semantic analysis.

8. The method of generating said at least one assessment item of claim 1 wherein, for each said assessment item, said generating said at least one wrong answer per said assessment item is performed by using fuzzy logic.

9. The method of generating said at least one assessment item of claim 1 for each said assessment item also comprising, editing said assessment item by a human being.

10. A method of generating said at least one assessment item of claim 9, for each said assessment item also comprising:
a) said human being generating ontological information;
b) said ontological information being fed back into said database or information network.

11. The method of generating said at least one assessment item of claim 1 wherein, for each said assessment item, the operations performed by said query engine comprises:
a) selecting a list of URLs associated with said topic;
b) retrieving from the Web raw data associated with said list of URL's;
c) performing a semantic analysis on said raw data, said semantic analysis generating said right answer and said semantic context.

12. A method of generating said at least one assessment item as in claim 11 wherein, for each said assessment item, said URLs are generated by inputting said topic into a Web search engine.

13. A method of generating said at least one assessment item as in claim 11 wherein, for each said assessment item, said URLs are generated by inputting said topic into a social bookmark service.

14. A method of generating said at least one assessment item as in claim 11 wherein, for each said assessment item, said URLs are generated from links found on semantic tags on the Web.

15. A method of generating said at least one assessment item as in claim 11 wherein, for each said assessment item, said URLs are generated from a predetermined table.

16. A method of generating said at least one assessment item as in claim 1 wherein each assessment item has associated with it a degree of difficulty and each assessment taker has associated with him or her, a degree of proficiency, and said method also comprising estimating said difficulties and said proficiencies.

17. The method of generating said at least one assessment item of claim 16 also comprising generating a score for each said assessment item taken by each assessment taker, said score being based on the performance of said assessment taker in taking said assessment item.

18. A method of generating said at least one assessment item of claim 17 wherein said score is based in part on the time taken by said assessment taker to answer assessment.

19. A method for assessing the degree of knowledge of an assessment taker comprising:
a) configuring a database or network to produce, when a query is issued to it, a right answer and at least one wrong answer;
b) formulating said query;
c) entering said query into said database or network;
d) retrieving said right answer from said database or network;
e) retrieving said at least one wrong answer from said database or network;
f) generating an assessment item comprising said query, said right answer and said at least one wrong answer;
g) producing said assessment item in a material form configured to be administered to an assessment taker; and
h) administering said assessment item to said assessment taker.

20. A method for assessing the degree of knowledge of an assessment taker comprising:
a) configuring an assessment generation engine running on a database or an information network to produce when a topic is specified, an assessment item comprising:
i) a true statement about said topic; and
ii) at least one false statement about said topic;
b) generating said assessment item comprising said true statement and said at least one false statement; and
c) administering said assessment item to said assessment taker.
